(19) United States
(12) Patent Application Publication
(10) Pub. No.: US 2007/0234950 A1
(43) Pub. Date: Oct. 11, 2007

(54) Portable moistener apparatus and methods thereof

(76) Inventor: Denise Watts, Henderson, NV (US)

Correspondence Address: DAVID LANDMAN, PH.D., 1617 CARDINAL BLUFF DR., # 202, LAS VEGAS, NV, 89128, US

(21) Appl. No.: 11/394,432

(22) Filed: Apr. 1, 2006

(51) Int. Cl. B05C 11/00

(52) U.S. Cl. 118/270

(57) ABSTRACT

A moistener apparatus to facilitate object handling is disclosed. The moistener apparatus comprises a housing and includes a valve system configured to selectively dispense a fluid from an inner portion of the housing. A portion of an outer surface of the valve system may be adapted to couple to a portion of a container configured to receive the moistener apparatus. The moistener apparatus may further comprise one or more cushioning pads extending from an outer surface of the housing to prevent undue fluid loss from the moistener apparatus while using the moistener apparatus during play of a sport. The container may further comprise one or more absorbent pads adapted to absorb excess fluid dispensed from the housing and to facilitate object handling by contacting a portion of the absorbent pad containing excess fluid. One or more moistener apparatus and containers may be packaged as a moistener kit.

### FIELD OF THE INVENTION

This invention relates to moisteners, and more specifically, to portable moistener apparatus used in sports, commercial applications and the like, and methods where sanitary moistening of hands and/or fingers facilitates object manipulation.

### BACKGROUND OF THE INVENTION

In the past, various types of moisteners have been disclosed which permit wetting of fingers to facilitate handling of money or separation of sheets of material such as plastic bags. An example disclosure includes a sponge cup disclosed by Sengbush et al. U.S. Pat. No. 2,658,474.

In general such devices are configured as a dispenser from which a quantity of liquid may be dispensed on a person's fingers. As disclosed more recently by Arsene et al., U.S. Pat. No. 4,858,555 one consideration for such dispensers is to provide a closure in a housing of the dispenser to prevent evaporative loss of liquid from the housing.

Such dispensers are also generally configured to be placed on a surface and, accessed by a user when needed. In other words, if the dispenser is needed elsewhere, the user may need to move the dispenser to a different location. For applications where a user needs to frequently move from one location to another and use a moistener, it would be preferable to configure the dispenser so that the user may easily access the moistener wherever the user is located.

For example during a sporting event such as football, a quarterback may lick his fingers to better grip the ball. In basketball many players lick their fingers before a free throw, while in baseball players may use resin or chalk bags to enhance grip of the ball, but could just as easily lick their fingers. Typically, a game environment is unsanitary and licking fingers may be considered to be unpleasant to many spectators. However, there has been no device or method for a player to conveniently improve ball-grip handling in a portable fashion during a game.

### SUMMARY OF THE INVENTION

For the foregoing reasons, there is a need to provide improved moistener apparatus that may be easily carried by a user for convenient use. Furthermore, the apparatus may be used in other environments such as currency counting, document distribution, parcel and mail sorting/distribution and separation of bulk plastic bags. Such apparatus should provide a more hygienic method to moisten fingers and thereby provide enhanced grip of objects. Furthermore, such apparatus should be sufficiently portable so that a user may have simple access to a moisture or tack source. Preferably, such an apparatus should comprise a liquid that is not harmful to the user.

Accordingly, it is an object of this invention to provide an improved moistener apparatus suitable for portable use by a user.

It is a further object of this invention to provide an improved moistener apparatus that comprises a safe fluid source.

It is a yet further object of this invention to provide an improved moistener apparatus wherein a moistener assembly may be readily replaced and provided as a kit.

It is a further object of this invention to provide an improved moistener apparatus further comprising a hand warmer for use by sports players in cold weather.

It is a still further object of this invention to provide a method for using an improved moistener apparatus to facilitate sanitary and convenient object handling.

### PREFERRED EMBODIMENTS OF THE INVENTION

In accordance with an embodiment of this invention, an assembly to facilitate object handling is disclosed. The assembly comprises, in combination, a moistener apparatus having a housing, the housing including a valve system and a container having a first member, a second member having an opening and a third member, a portion of the first member coupled to at least one of a portion of the second member and a portion of the third member. A first region between the second member and the third member is configured to receive the moistener apparatus. A portion of the valve system is coupled to a portion of the second member, and a second region between the first member and the second member is configured to selectively receive a fluid from an inner-portion of the housing thereby facilitating object handling when the fluid is contacted.

The assembly further comprises at least one cushioning pad extending outwardly from an outer surface of the housing to prevent undue loss of the fluid from the moistener apparatus. Furthermore, the assembly comprises at least one absorbent pad coupled to an inner surface of at least one of the first member and the second member. The absorbent pad may be configured to receive excess of the fluid dispensed from the housing.

In accordance with another embodiment of this invention, a method for facilitating object handling is disclosed. In the method a moistener apparatus is provided having a housing, the housing including a valve system. The housing is mounted in a region of a container having an opening configured to couple to a portion of the valve system. A portion of an outer surface of the valve system is coupled to a peripheral portion of the opening. A quantity of fluid from an inner portion of the housing is selectively dispensed to facilitate handling of an object by a user of the moistener apparatus.

In accordance with another embodiment of this invention, a moistener kit to facilitate object handling is disclosed. The kit comprises, in combination, at least one moistener apparatus having a housing. The housing includes a valve system configured to selectively dispense a fluid from an inner portion of the housing. A portion of an outer surface of the valve system is adapted to couple to a portion of a container configured to receive the at least one moistener apparatus and an outer packaging material conforms to at least a portion of the shape of the at least one moistener apparatus.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a front side perspective view of an assembly comprising a moistener apparatus configured for mounting in a portion of a container in accordance with an exemplary embodiment of this invention.

FIG. 2 is a front side perspective view of an exemplary embodiment of the container of FIG. 1.

FIG. 2A is a front side perspective view of another embodiment of the container of FIG. 1.

FIG. 2B is a front side perspective view of yet another embodiment of the container of FIG. 1.

FIG. 3 is front side perspective view of the moistener apparatus of FIG. 1.

FIG. 3A is a sectional view through 3A-3A of the moistener apparatus of FIG. 3.

FIG. 3B is a perspective view depicting a valve of the moistener apparatus of FIG. 3 in a closed position.

FIG. 3C is a perspective view depicting a valve of the moistener apparatus of FIG. 3 in an open position.

FIGS. 4A-4D illustrates a process for inserting and coupling the moistener apparatus into the container of FIG. 1.

FIG. 5 is a front side perspective view of an assembly comprising a moistener apparatus configured for mounting in a portion of container including a heat pack in accordance with another exemplary embodiment of this invention.

FIG. 5A is a back perspective view of the container of FIG. 5.

FIG. 5B is a front perspective view of a football player using the assembly comprising the moistener apparatus and the container of FIG. 5.

FIG. 6 is a front perspective view of a player using the assembly comprising the moistener apparatus and the container of FIG. 1.

FIG. 6A is a front perspective view of the moistener apparatus of FIG. 1 with a hand manipulating the moistener apparatus to dispense a fluid from the moistener apparatus in the container (shown as phantom lines).

FIG. 7A is a top perspective view of an embodiment of a kit according to the invention.

FIG. 7B is a front perspective view of another embodiment of a kit.

FIG. 7C is a front perspective view of yet another embodiment of a kit.

### DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In the Summary and Preferred Embodiments above, the Description of the Invention, and the Claims and Abstract below, and in the accompanying drawings, reference may be made to particular features (including method steps) of the invention. It is to be understood that this disclosure includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention, and in the invention generally.

The term “comprises” and grammatical equivalents thereof are used herein to mean that other components, ingredients, steps etc. are optionally present. For example, an article “comprising” (or “which comprises”) components A, B and C can consist of (i.e. contain only) components A, B and C, or can contain not only components A, B and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility. The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit or a range having no lower limit, depending upon the variable being defined). For example, “at most 4” means 4 or less than 4, and “at most 40%” means 40% or less than 40%. When, in this disclosure, a range is given as “(a first number) to (a second number)” or “(a first number)-(a second number)”, this means a range whose lower limit is the first number and whose upper limit is the second number. For example, 25-100 mm means a range whose lower limit is 25 mm, and whose upper limit is 100 mm.

The term “or” is used herein as a conjunction used to link alternatives in a series of alternatives. The term “and/or” is used herein as a conjunction meaning that either or both of two options may be valid.

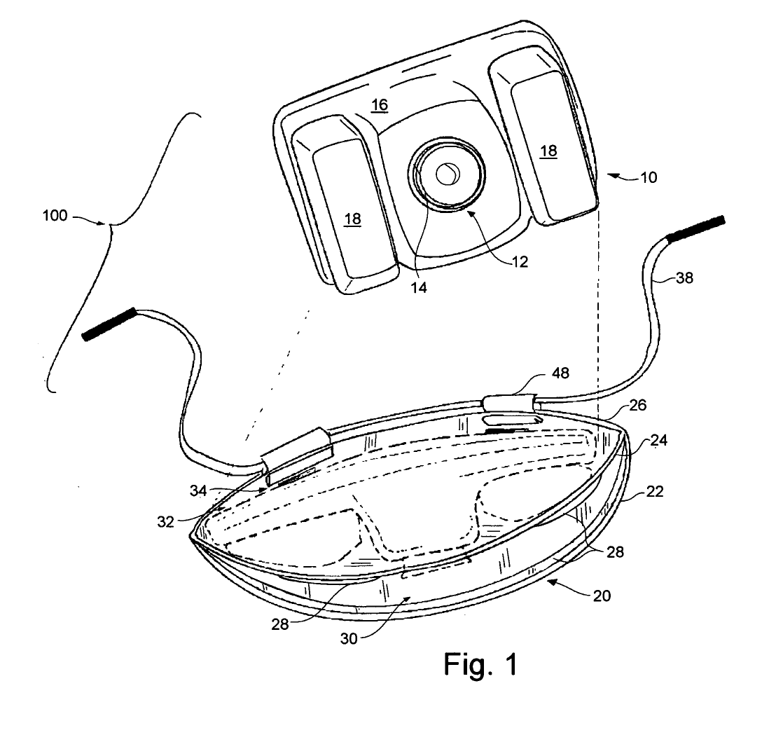

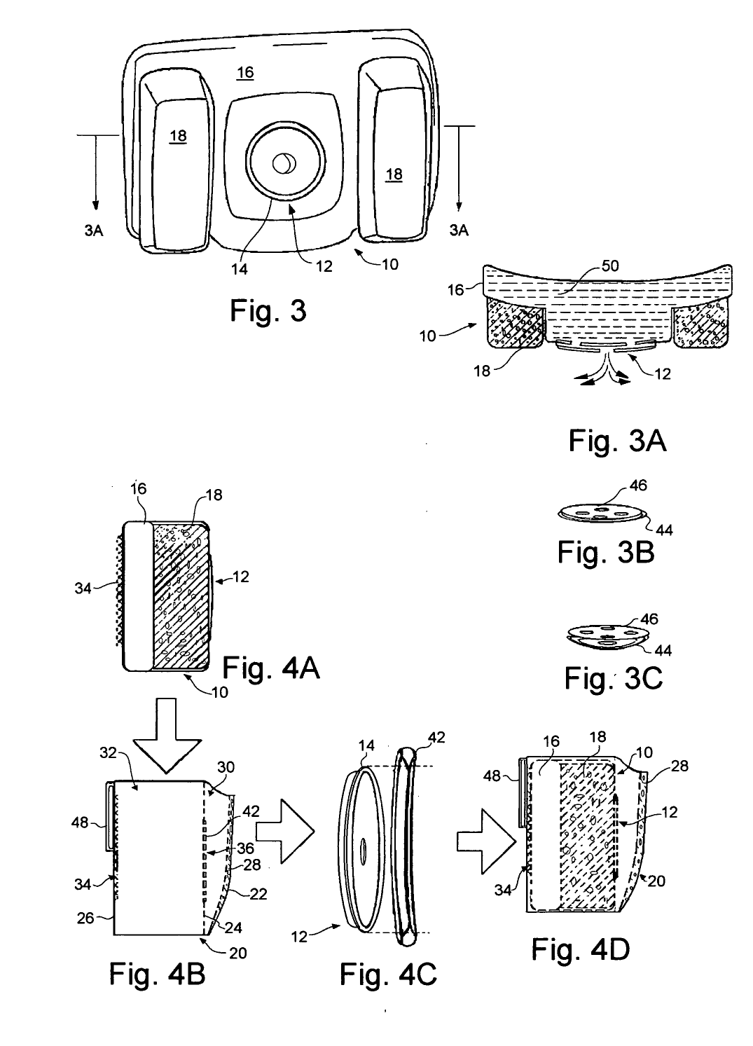

FIG. 1 depicts an embodiment of an assembly 100 comprising a portable container 20 configured to receive a moistener apparatus 10. With reference to FIG. 1, dotted lines indicate positioning of the moistener apparatus 10 in the container 20. The moistening apparatus 10 comprises a fluid 50 or liquid (see FIG. 3A and description below) located in a housing 16. The fluid 50 may flow from the housing 16 through a valve system 12 (see FIGS. 3B and 3C and description below). Furthermore, the moistening apparatus 10 may comprise one or more protective or cushioning pads 18. Protective pads 18 project outwardly from a front surface of the housing 16 (see further description below with reference to FIG. 3A).

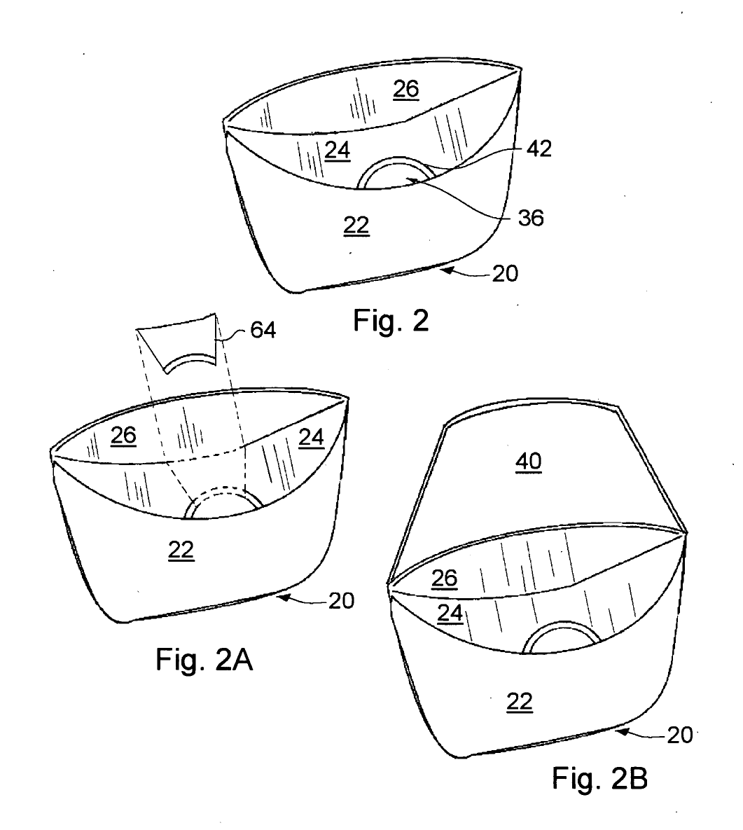

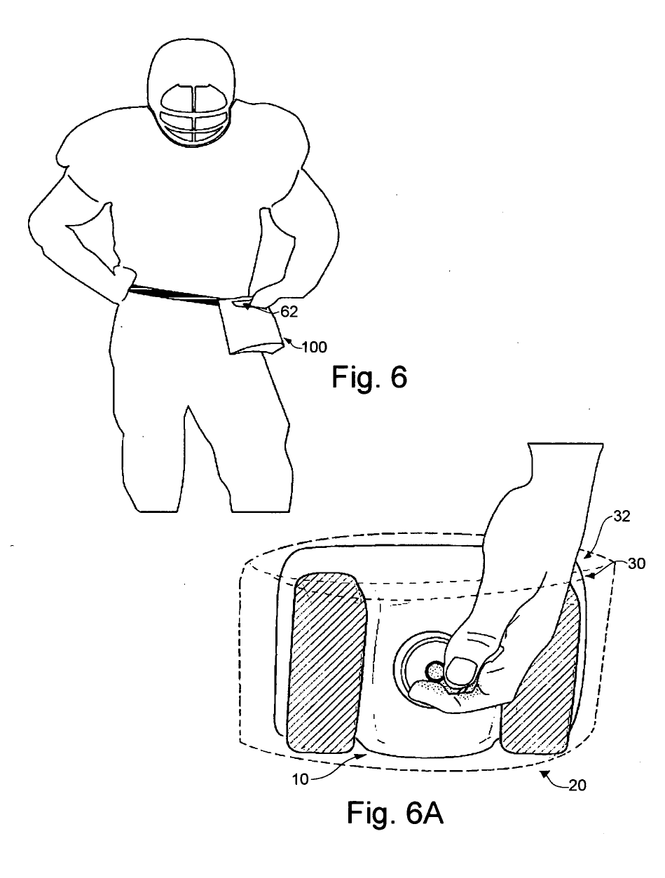

The container 20 comprises a first member 22 and a second member 24 with a substantial portion of the first member coupled to a substantial portion of the second member. The first member 22 and the second member 24 define a dispensing region 30 of the container 20 for accessing the moistener apparatus 10 by a user (see FIG. 6A and the description below). Furthermore, the container 10 comprises a third member 26 coupled to both a substantial portion of the first member 22 and/or a substantial portion of the second member 24. The second member 24 and the third member 26 define a region 32 configured for receiving the moistener apparatus 10. A portion of the second member 24 has an opening 36 (see FIGS. 2, 2A, 2B and the description below) configured to receive a valve rim 14 of the valve system 12 of the moistener apparatus 10. An outer portion of the valve rim 14 selectively couples to a container rim 42 peripheral to the opening 36. In a preferred embodiment the valve rim 14 and the container rim 42 comprise any type of semi-rigid plastic.

A portion of an inner surface of the first member 22 of the container 10 may comprise one or more absorbent pads 28. The absorbent pad 28 may receive any excess fluid flowing from the housing 16 through the valve system 12. It is understood that the absorbent pads 28 may also be located on a portion of the surface of the second member 24. In an exemplary embodiment the pads 28 may comprise a pliable foam composition that may be a synthetic material such as polyurethane and the like, or a non-synthetic such as a sponge. The pads 28 may comprise a felt or any other suitable structure configured to absorb a fluid. Since the pads 28 may absorb excess fluid and retain some of the fluid for a short period of time, prior to natural evaporation, a user may also use the pads in a secondary fashion to moisten the user's fingers and/or hands.

An inner portion of the third member 26 may comprise a first portion of a hook-and-loop system 34 configured to selectively couple to an outer surface of the moistener apparatus 10 having a second portion of the hook-and-loop system. The hook-and-loop system 34 together with the opening 36 stabilize placement of the moistener apparatus 10 in the container 20. The moistener apparatus 10 may be selectively coupled to the container 20 in various ways. Optionally, the moistener apparatus 10 may be permanently coupled to the container 20.

In an embodiment of the moistener apparatus 10, the housing 16 may comprise a pliant or semi-rigid water resistant polymer having any suitable shape or design. Pliant or semi-rigid polymers may comprise any suitable plastic or rubber including polyolefins such as neoprene, polyethylene, polypropylene, EPDM (ethylene/propylene/dicyclopentadiene polymers), polyesters such as polyethylene terephthalate, polyvinyl halides such as polyvinyl chloride, polyamides such as nylon and the like and any formulations or combinations of these polymers, copolymers and any other suitable polymers as is understood in the art. Furthermore, the housing 16 may comprise a substantially rigid plastic enclosing a pliable plastic inner container configured to surround the fluid 50 (not shown). The pliable inner container may comprise a flexible plastic such as polyethylene, polypropylene, combinations thereof and the like. Furthermore, the pliable inner container may comprise a metallic film (such as aluminum) coating the flexible plastic to prevent freezing of the fluid 50 (not shown).

The moistener apparatus 10 may further comprise a substantially see-through (transparent or translucent) indicator or gauge (not shown) configured to permit observation of the level of the fluid 50 within the housing 16.

A portion of an outer surface of the third member 26 of the container 20 may comprise one or more loops 48 configured to receive a belt, band, ribbon or strap 38 for facile transportation of the assembly 100. Advantageously, a user of the assembly 100 may wear the assembly and readily access the moistener apparatus 10 when required by the user such as during a sporting activity. Of course the container 20 may be configured in other ways, as is understood in the art, for convenient access by a user during any type of activity and have no loops or straps, so that the container may be coupled to a surface. An example of such a configuration may be when the user is a clerk handling currency, documents and the like.

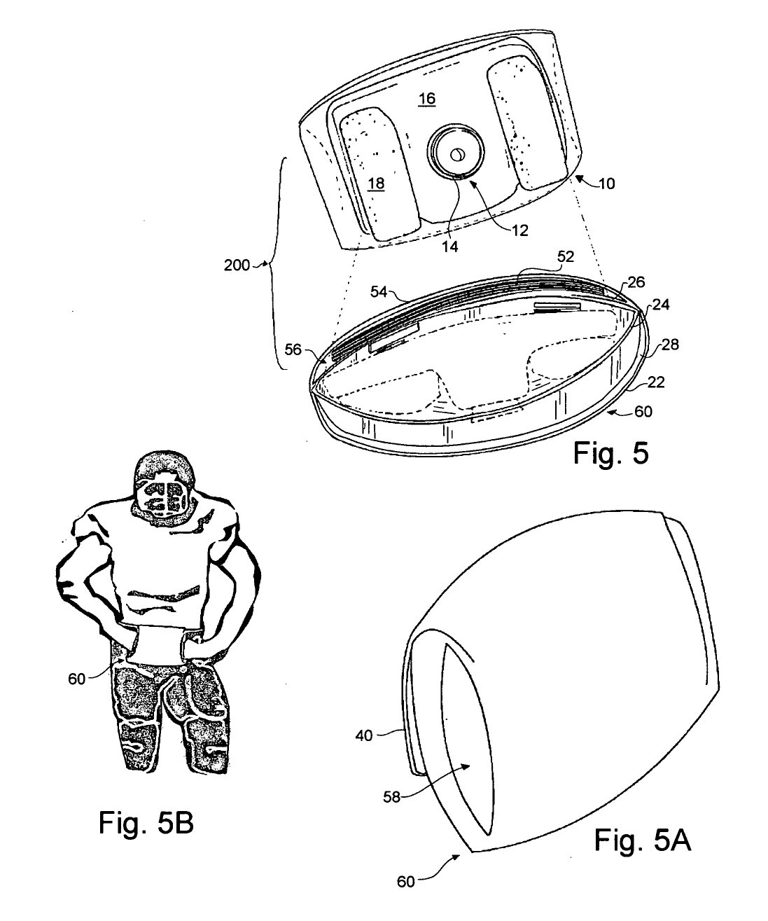

FIG. 2 illustrates a front perspective view of an embodiment of the container 20. As described above, in this embodiment the container 20 comprises the first member 22 having a substantially rectangular shape coupled to the second member 24 having the opening 36 with the container rim 42 on a peripheral portion defining the opening. The third member 26 may be coupled to a portion of the second member 24 and/or a substantial portion of the first member 22. Of course any combination of the first, second and third members 22, 24, 26 may be contiguous, and therefore the container 20 may comprise two members forming walls of the container. In principle the container 20 may be any suitable shape configured to receive the moistener apparatus 10. Furthermore, access to regions 30 and 32 may be from a top portion of the container 20 as illustrated in FIGS. 2, 2A and 2B or from a side portion of the container (as illustrated in FIG. 5A (see description below).

In another embodiment of the container 20 illustrated in FIG. 2A, a portion 64 of the second member 24 may be selectively removed to facilitate coupling to an outer portion of the valve system 12. In operation, when the outer portion of valve system 12 seats in the opening 36, the portion 64 may be replaced and thereby lock the moistener apparatus 10 in the container 20. Of course, the portion 64 may be pivotally coupled to the second member 24 rather than being removed and later coupled back to the second member.

In another embodiment of the container 20 illustrated in FIG. 2B, the third member 26 may be extended to define a flap 40. The flap 40 may fold over the regions 30 and 32 defined by the first member 22, the second member 24 and the third member 26 to prevent undue loss of fluid by evaporation. Alternatively, the flap 40 may be an extension of the member 24 configured to fold over the region 30. Of course the flap 40 may be coupled to an outer surface of the first member 22 (not shown) in a variety of ways as is understood in the art. However, in a preferred embodiment, the flap 40 simply covers the regions 30 and 32 to permit rapid access to the region 30 and thereby access to the fluid 50 dispensed through the valve system 12.

The container 20 may comprise any suitable substantially water proof or water resistant material. Examples of suitable materials include, but are not limited to nylon, polyester, canvas and the like coated with a substantially hydrophobic material such as polyethylene, polyvinyl chloride, polyurethane, fluoropolymer (such as polytetrafluoethylene) and the like. In a preferred embodiment, the housing 16 of the moistener apparatus 10 may be sized for a capacity of at least about 6 fluid ounces of fluid, although it is understood that the housing may be any convenient size.

FIG. 3 illustrates a front perspective view of the moistener apparatus 10 including the housing 16, the valve system 12 and the cushioning pads 18. FIG. 3A illustrates a sectional view through 3A-3A of the moistener apparatus 10 showing an inner portion of the moistener apparatus. The inner portion of the moistener apparatus 10 may be substantially hollow and filled with the fluid 50. The inner portion of the moistener apparatus 10 is in fluid communication with the valve system 12 to permit flow of the fluid 50 when dispensed from the moistener apparatus.

As illustrated in FIGS. 3B and 3C, the valve system 12 comprises a first valve member 44 having one or more apertures and a second valve member 46 having one or more openings, with the one or more apertures of the first valve member out of registration with the one or more openings of the second valve member. The valve members 44, 46 of the valve system 12 may comprise any suitable semi-rigid material such as polyethylene or any other polymer, copolymer and formulations thereof as is understood in the art. In operation when valve members 44 and 46 are engaged, no fluid 50 flows through the valve system 12. However, when valve members 44, 46 are separated, fluid 50 may flow from an inner portion of housing 16 of the moistener apparatus 10 through one or more openings of the second valve member 46 to the one or more apertures of the first valve member 44. It is understood that both members 44, 46 conform to each other when the housing 16 of the moistener apparatus 10 is uncompressed. Of course, the amount of fluid dispensed may be controlled by design features such as size of apertures and holes, contour of the first and second valve members 44, 46, choice of materials and other factors understood in the art. In one embodiment at least about ¼ (one-fourth) fluid ounces of the fluid 50 may be dispensed from the valve system 12 each time valve system is accessed such as by pumping or squeezing the housing 16, although it is understood that any quantity of fluid may be dispensed. In principle, the valve system 12 may comprise any valve arrangement that conveniently delivers a quantity of fluid 50 on demand.

The one or more apertures of the valve system 12 may be selectively blocked with for example a pressure sensitive tape (not shown) or a cap (not shown) prior to installation of the moistener apparatus 10 into the container 20 to prevent loss of fluid 50. In operation, when the valve system 12 is securely fastened in the container 20, the one or more apertures may be unblocked by removing the tape, cap or any other suitable temporary obstruction as is understood in the art.

The fluid 50 in the moistener apparatus 10 may be any type of suitable liquid to provide enhanced gripping capability. In one embodiment, the liquid may be water or any water based formulation. Preferably the liquid comprises non-toxic ingestible components since it may be possible that a user may revert back to licking the user's fingers inadvertently or the user's fingers may contact another person. In another embodiment the liquid may comprise an antifreeze mixture with water such as ethyl alcohol, ethylene glycol, diethylene glycol and water or a polyacrylate polyalcohol co-polymer refrigerant and water to permit use of the moistener apparatus 10 in colder weather environments. Of course, other water formulations comprising water soluble salts that provide a freezing point depression as is understood in the art may also be useful. Such formulations may be configured as lotions and also comprise emollients, suitable non-toxic scents, non-toxic colorants and humectants (such as propylene glycol, polyethylene glycol, combinations thereof and the like as is understood in the art) to enhance gripping and handling of objects such as balls during a sporting event.

Returning to FIG. 3A, the protective or cushioning pads 18 may protrude outwardly from an outer surface of the housing 16 to a greater extent than the valve system 12 of the moistening apparatus 10. The pads 18 may comprise a portion of the housing 16 (such being a unitary molding) or may be coupled to a portion of the surface of the housing. One benefit of this arrangement is to prevent undue loss of fluid 50 from the moistener apparatus 10 should a user fall regularly or be pushed as, for example, may happen during a contact sports event. In an exemplary embodiment the pads 18 may comprise a durable semi-rigid foam composition of a synthetic material such as polyurethane, styrene, styrene-butadiene, neoprene, low density polyethylene, plasticized polyvinyl chloride and copolymers and the like, or a non-synthetic material such as a sponge or natural rubber.

FIGS. 4A-4D illustrates a process for loading the moistener apparatus 10 into the container 20. FIG. 4A is an end elevational view of the moistener apparatus 10 showing a portion of the hook-and-loop system 34. FIG. 4B is an end elevational view of the container 20 showing a portion of the hook-and-loop system 34, the first, second and third members 22, 24, 26, the container rim 42 peripherally surrounding the opening 36 configured to receive the valve system 12 and the loops 48 configured to receive one or more belts or straps 38. Naturally, the loops 48 and straps 38 combination may be configured as a clip system or a hook-and-loop system or any other selective coupling system as is understood in the art.

FIG. 4C is an exploded perspective view of the valve system 12 including the valve rim 14 which may be coupled to the container rim 42 defining a periphery of the opening 36 of the container 20. As illustrated, the container rim 42 may have an indented portion sized to engage with the valve rim 14.

FIG. 4D is an end elevational view showing the container 20 with the moistener apparatus coupled therein (shown in dotted lines).

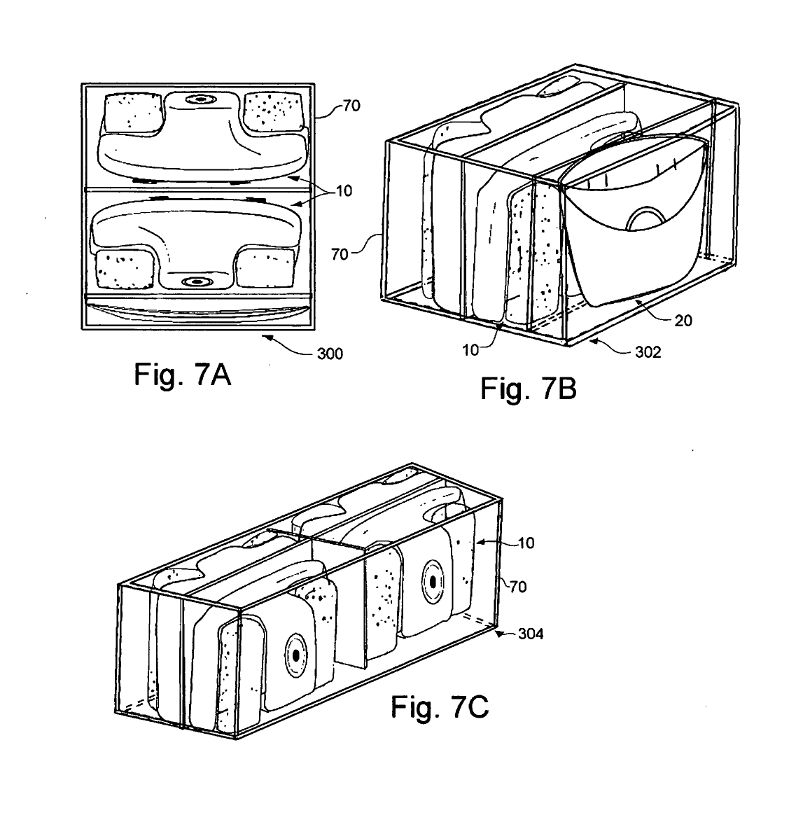

In operation, a user may remove the moistener apparatus 10 from a package 70 (see FIG. 7A and the description below). The user may load the moistener apparatus 10 into the container 20. Furthermore, the user may couple the valve rim 14 to the container rim 42 to provide the assembly 100 comprising the moistener apparatus 10 and the container 20. Since one or more apertures of the valve system 12 may be pre-taped, covered or capped to prevent loss of fluid, the user may remove the tape, cover or cap prior to using the moistener apparatus 10. During an event such as a football or basketball game the user may squeeze a portion of the moistener apparatus 10 to force out a measured amount of the fluid 50 from the housing 16. Once the fluid 50 is expelled the user's ball handling ability may be improved. Furthermore, if excess fluid 50 flows onto the absorbent pad 28, the user may simply touch the absorbent pad to receive a portion of the fluid on the user's fingers without accessing the valve system 12. Alternatively, if the user has excess fluid 50 on the user's fingers, the user may wipe the excess fluid onto the absorbent pad 28.

When the moistener apparatus 10 no longer has any fluid 50 therein, a user may decouple the moistener apparatus from the container 20. Subsequently, the user may couple a new moistener apparatus 10 to the container 20 as described above. In one embodiment the housing 16 of the moistener apparatus 10 may be refilled with a fluid 50. However, it is preferred that the moistener apparatus 10 be replaced with a new moistener apparatus (see FIGS. 7A-D and the description below of a kit).

Another embodiment of an assembly 200 is illustrated in FIG. 5. The assembly 200 comprises the moistener apparatus 10 (same as described above) and another embodiment of a container 60 sized to receive the moistener apparatus. The container 60 comprises a first member 22, a second member 24, a third member 26 and a fourth member 54. Of course any and all of these members 22, 24, 26 and 54 may be combined to provide single structural elements. For example members 22 and 24 may comprise a single structural element. Alternatively, members 22 and 54 may comprise a single structural element.

As described above, members 22 and 24 may be substantially coupled and define a first region 30 of the container 60 wherein fluid 50 may be dispensed from the housing 16 of the moistener apparatus 10. Similarly members 24 and 26 may be substantially coupled and define a second region 32 configured to receive the moistener apparatus 10. Members 26 and 54 may also be substantially coupled and define a third region 56. The third region 56 may be configured to receive a hand warmer 52. Naturally, the hand warmer 52 may be selectively coupled to a portion of an inner surface of the third member 26 or a portion of an inner surface of the fourth member 54. Advantageously the hand warmer 52 combined with the moistener apparatus 10 may facilitate better grip action because a user's hands would be limber to provide greater user comfort and have sufficient fluid to ensure better gripping of a ball during an outdoor sports event such as football.

FIG. 5A illustrates a back perspective view of the container 60. The container 60 may comprise a flap 40. Additionally, the container 60 may have one or more openings 58 located on one or more sides of the container so that a user may access fluid dispensed from the moistener apparatus 10 disposed therein. Furthermore, the user may access the hand warmer 52 through the one or more openings 58.

Optionally, it is understood that a container 20 as illustrated in FIG. 2 with top access to the moistener apparatus 10 (see description above) may placed in a shell having the outer shape and design features of container 60 shown in FIG. 5A. An inner portion of the shell may comprise the hand warmer 52. A user may access assembly 100 comprising the combination moistener apparatus 10 and container 20 through one or more side openings and also enjoy the benefit of the hand warmer 42.

FIG. 5B provides a more detailed illustration of use of the container 60, wherein a user may place both the user's hands in the openings 58 of the container. Of course, when the moistener apparatus 10 no longer has any fluid, the user may conveniently change out the moistener apparatus as described above by raising the flap 40, uncoupling the non-fluid containing moistener apparatus and coupling a new moistener apparatus to the container 60. Subsequently, the user may lower the flap over regions 30, 32 and 56 of the container 60.

FIG. 6 illustrates another embodiment of the assembly 100 worn by a user wherein the moistener apparatus 10 of the assembly may be accessed from a container having a single opening 62. Of course, an inner portion of the container (not shown) may be segmented as described above for the embodiments of the container 20 and 60. FIG. 6A more clearly illustrates use of the assembly 100. In particular, referring to FIG. 6A, the moistener apparatus 10 is shown within the container 20 (depicted by dotted lines) with the housing 16 located in region 32 and a portion of the valve system in region 30. A user's hand may be also located in region 30 and may be positioned to press on a portion of the member 24 and subsequently on a portion of the housing 16 or on a portion of the valve system 12. When the first and second valve members 44, 46 of the valve system 12 are separated by the user's pressing action, the fluid may be dispensed as described above (see above description of FIGS. 4A-4D).

The moistener apparatus 10 and/or the container 20 (or 60) may be provided as kits. For example, referring to FIG. 7A, a moistener kit 300 comprises a pair of the moistener apparatus 10 in a package 70 (depicted in FIGS. 7A-C as dotted lines surrounding the moistener apparatus and/or the containers 20, 60). In another embodiment of a kit 302, a pair of the moistener apparatus 10 and a container such as container 20 may be enclosed in a package 70 (see FIG. 7B) FIG. 7C depicts another embodiment of a kit 304 comprising a multiplicity (four shown) of the moistener apparatus 10 in a package 70. Without limiting the disclosure, it is understood that the kit may comprise any combination of one or more of the moistener apparatus 10 and/or of the containers 20, 60. The package may comprise a substantially transparent or translucent material such as polyethylene or cellophane packaging which may conform to the shape of the contents of the kit. When a user of the assembly 100 (comprising the moistener apparatus 10 and the container 20) or the assembly 200 (comprising the moistener apparatus 10 and the container 60) contemplates purchase of further consumables for the assembly (such as the moistener apparatus), the kit provides a convenient form to receive such consumables in bulk.

Without limiting the disclosure, it will be appreciated that circumstances requiring frequent object manipulation or separation of a multiplicity of elements such as currency, documents, packaging and the like may benefit from use of the assembly comprising the moistener apparatus and container combinations described herein. For example, a shopper may observe a clerk licking his or her fingers to help separate polyethylene bags. Such shoppers may be inclined to discontinue shopping at stores where unhygienic behavior is observed.

While the invention has been particularly shown and described with reference to preferred embodiments thereof, it will be understood by those skilled in the art that the foregoing and other changes in form and details may be made therein without departing from the spirit and scope of the invention.

What is claimed is:

1. An assembly to facilitate object handling comprising, in combination:
a moistener apparatus having a housing, said housing including a valve system;
a container having a first member, a second member having an opening and a third member, a portion of said first member coupled to at least one of a portion of said second member and a portion of said third member;
a first region between said second member and said third member configured to receive said moistener apparatus;
a portion of said valve system coupled to a portion of said second member; and
a second region between said first member and said second member configured to selectively receive a fluid from an inner portion of said housing thereby facilitating object handling when said fluid is contacted.

2. The assembly of claim 1 further comprising at least one cushioning pad extending outwardly from an outer surface of said housing to prevent undue loss of said fluid from said moistener apparatus.

3. The assembly of claim 1 further comprising at least one absorbent pad coupled to an inner surface of at least one of said first member and said second member, said absorbent pad configured to receive excess of said fluid dispensed from said housing.

4. The assembly of claim 1 wherein said valve system comprises a first valve member having at least one opening and a second valve member having at least one opening, said first valve member substantially conforming to said second valve member, wherein a fluid flows from said at least one opening of said second valve member to said at least one opening of said first valve member if at least one of said first valve member and said second valve member are separated.

5. The assembly of claim 1 wherein said valve system comprises a valve rim on an outer surface of said valve system, said valve rim coupled to a container rim peripheral to said opening of said second member of said container.

6. The assembly of claim 1 wherein a portion of said container comprises a flap, said flap configured to cover at least said second region to prevent undue evaporative fluid loss.

7. The assembly of claim 1 further comprising a fourth member of said container, a portion of said fourth member coupled to at least one of said first member, said second member and said third member, and a region between said fourth member and said third member configured to receive a hand warmer.

8. The assembly of claim 1 further comprising at least one loop coupled to a portion of an outer surface of said container, said at least one loop configured for wearing said assembly.

9. The assembly of claim 1 wherein said container comprises a substantially water proof material.

10. The assembly of claim 9 wherein a portion of said water proof material comprises at least one of nylon, polyester and canvas.

11. The assembly of claim 10 further comprising at least one hydrophobic polymer coating selected from the group consisting of at least one of polyethylene, polyvinyl chloride, polyurethane and a fluoropolymer.

12. The assembly of claim 1 wherein said housing has a capacity of at least about 6 fluid ounces of fluid.

13. The assembly of claim 1 wherein said valve system is configured to dispense at least about ¼ fluid ounce of said fluid each time said valve system is accessed.

14. The assembly of claim 1 wherein said housing comprises a substantially water proof semi-rigid polymer selected from the group consisting of polyolefin, polyester, polyvinyl halide, polyamide and copolymers thereof.

15. The assembly of claim 1 wherein said fluid comprises a non-toxic freezing point depressant mixture with water, said freezing point depressant selected from the group consisting of at least one of ethyl alcohol, ethylene glycol, diethylene glycol, polyacrylate polyalcohol co-polymer and salts.

16. The assembly of claim 2 wherein said at least one cushioning pad comprises at least one of a substantially semi-rigid foamed polymer, a sponge and a rubber, said semi-rigid foamed polymer selected from the group consisting of at least one of polyurethane, styrene, styrene-butadiene, neoprene, low density polyethylene, plasticized polyvinyl chloride and copolymers thereof.

17. A method for facilitating object handling, comprising the steps of:
providing a moistener apparatus having a housing, said housing including a valve system;
mounting said housing in a region of a container having an opening configured to couple to a portion of said valve system;
coupling a portion of an outer surface of said valve system to a peripheral portion of said opening; and
selectively dispensing a quantity of fluid from an inner portion of said housing to facilitate handling of an object by a user of said moistener apparatus.

18. The method of claim 17 further comprising the steps of:
providing at least one cushioning pad extending outwardly from an outer surface of said housing; and
preventing undue fluid loss from said moistener apparatus.

19. The method of claim 17 further comprising the steps of:
providing at least one absorbent pad coupled to an inner surface of said container;
absorbing excess of said fluid dispensed from said housing with said at least one absorbent pad; and
contacting a portion of said at least one absorbent pad to facilitate object handling.

20. A moistener kit to facilitate object handling comprising, in combination:
at least one moistener apparatus having a housing, said housing including a valve system configured to selectively dispense a fluid from an inner portion of said housing;
a portion of an outer surface of said valve system adapted to couple to a portion of a container configured to receive said at least one moistener apparatus; and
an outer packaging material conforming to at least a portion of the shape of said at least one moistener apparatus.
